(19) United States
(12) Patent Application Publication
(10) Pub. No.: US 2015/0206152 A1
(43) Pub. Date: Jul. 23, 2015

(54) ANTI-COUNTERFEITING TECHNIQUE VIA ATTRIBUTES

(71) Applicant: New York University, New York, NY (US)

(72) Inventors: Dennis Shasha, New York, NY (US); Michael D. Ward, New York, NY (US)

(73) Assignee: New York University, New York, NY (US)

(21) Appl. No.: 14/417,731

(22) PCT Filed: Jul. 30, 2013
(86) PCT No.: PCT/US2013/052753

§ 371 Date: Jan. 27, 2015

Related U.S. Application Data
(60) Provisional application No. 61/677,618, filed on Jul. 31, 2012.
(60) Provisional application No. 61/727,515, filed on Nov. 16, 2012.

(51) Int. Cl. G06Q 30/00

(52) U.S. Cl. CPC G06Q 30/0185

(57) ABSTRACT

Methods, systems, and apparatuses, including computer programs encoded on computer-readable media, for receiving an item identifier that identifies an item and an attribute associated with an item. The received attribute is based upon a hidden attribute that is revealed upon analysis of the item. If the received attribute matches an expected attribute, which is associated with the item identifier, is determined.

### CROSS-REFERENCE TO RELATED APPLICATIONS

This application is a U.S. National Phase application of PCT/US2013/052753 filed Jul. 30, 2013, which claims the benefit of U.S. Provisional Application No. 61/677,618 filed Jul. 31, 2012, and U.S. Provisional Application No. 61/727,515 filed Nov. 16, 2012. All of which are hereby incorporated by reference in their entirety.

### BACKGROUND

Up to 1% of prescribed drugs in the developed world and up to 30% of prescribed drugs in the developing world may be counterfeit. In addition, up to 50% of drugs available online through illegal pharmacies are believed to be counterfeit. Packaging used to distribute drugs is one factor in combating counterfeit products. Rules and regulations help ensure that pharmaceutical packaging cannot be easily duplicated. In addition, pill packaging can include a code that can be sent via text message. The received code can be verified as being an authentic code. A code, however, does not guarantee that the pills in the packaging are the actual pills from the drug company. Additional techniques can require expensive equipment and/or specialized and trusted personal. For example, portable quality analysis kits can be used to test a limited number of drugs. Pills can also have small modifications made that are not seen by the naked eye but are detectable by expensive machinery

### SUMMARY

In general, one aspect of the subject matter described in this specification can be embodied in a product that includes a plurality of items. Each has an identifier and a hidden attribute. Each item is configured to reveal the hidden attribute upon consumption. The item identifier may be a single character or image sequence. It may also be broken down into separate fields such as product identifier, group identifier, and an identifier within a group. An item identifier identifies one or more items. The attribute is based upon a hidden attribute that is revealed upon consumption of the item, and the item has a predetermined association with the item identifier. The received attribute is tested to see whether it matches an expected attribute, wherein the expected attribute is associated with the item identifier. Other implementations of these aspects include corresponding systems, apparatuses, and computer-readable media configured to perform the actions of the method.

In an alternative embodiment, each item has an identifier and a hidden attribute. Each item is configured to reveal the hidden attribute upon examination by a specialized device. An item identifier may be separated into a group identifier associated for example with a package of items and a product identifier-to distinguish items within that group. Another aspect is a method for receiving a product identifier, a group identifier, and an attribute associated with an item. An item identifier is associated with one or more items and comprises the product identifier and the group identifier. The attribute is based upon a hidden attribute that is revealed upon examination by a specialized device of the item, and the item is associated with the item identifier. A test is performed to determine whether the received attribute matches an expected attribute, wherein the expected attribute is associated with the item identifier. Other implementations of these aspects include corresponding systems, apparatuses, and computer-readable media configured to perform the actions of the method.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

FIG. 1 illustrates a pill package in accordance with an illustrative implementation.

FIG. 2 is a flow diagram for determining if item attributes are correct in accordance with an illustrative implementation.

FIG. 3 is a diagram of an ideal communication between supplier and consumer in accordance with an illustrative implementation.

FIG. 4 is a diagram of an intercept-replace attack in accordance with an illustrative implementation.

FIG. 5 is a block diagram of a computer system in accordance with an illustrative implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

This specification describes various techniques to prevent the counterfeiting of items. The item may be a consumable, such as a food or beverage. The item may also be a drug or supplement. As an example, an end user may want be sure the drug has come from a trusted source. In various embodiments, the user can also verify that a package of drugs is not from a particular source. To verify the source of a drug, one or more attributes can be added to the drug, e.g., an attribute added to each pill. An attribute may be the presence of an added compound or element or a particular characteristic of such an added compound or element. The attribute is such that it can be later determined. In one embodiment, attributes are characteristics that are easily observed upon consumption. For example, the color a pill upon consumption, the taste of the pill, the smell of the pill are non-limiting attribute examples. In addition to drugs, any consumables that are packaged in multiple units and can have an attribute added to the consumable that can be easily observed can have their source verified. In another embodiment, attributes are characteristics that can be observed by analyzing a consumable using a specialized device such as an X-Ray diffractometer, but not or only with great difficulty For example, the X-Ray profile of a substance within a pill is an example of an though this is non-limiting.

In one embodiment, the item may further be associated with a group identifier and/or a product identifier. As an example of an illustrative implementation, pill package can have an identifier (e.g. a large number, alphanumeric sequence, or geometric pattern) that is unique to that package and that is preferably difficult to guess. This constitutes a group identifier. So, forging without the identifier or with a false one or with a duplicate will be detected. The pills within the pill package can be numbered slots in the package. Thus, the item identifier may consist of a product name (e.g. which type of pill), a package identifier, and the number of the pill within a package. Each pill will leave the tongue with a particular color that comes from inert food coloring inside the pill (or the pill will have a particular taste or a particular Each package may have colors placed in a different and unique pattern. For in one package, pill 1 has red dye, pill 2 has blue, pill 3 has red, pill 4 has green, etc. another package pill 1 has blue, pill 2 has green, pill 3 has green, pill 4 has red, etc. The attribute value may or may not depend on the active ingredient in the medicine.

As the user consumes the pills, he or she can log into a server and check that the colors are correct for this package identifier. The server keeps track of correct and incorrect guesses. If there are several attempts, e.g., more than 3, 4, 5, etc., with incorrect answers for the same package identifier, the server can either stop answering or report that the package is suspect to the next person who asks about it. Incorrect guesses might result from a counterfeiter guessing colors until he or she found the correct colors. A counterfeiter motivated to do that might then create his or her own packaging and fake pills with the proper colors. The identifier on each package will be preferably-not easy to guess so that a denial-of-service attacker cannot cause packages to appear invalid by guessing the identifier and then deliberately giving incorrect colors.

Alternatively, each package can have an attribute comprising a compound with a specific chemical composition and structure placed in a different and unique pattern. For example, in one package, pill 1 has compound A, pill 2 has compound B, pill 3 has compound A, pill 4 has compound A, etc. In another package pill 1 has compound B, pill 2 has compound A, pill 3 has compound B, pill 4 has compound B, etc. The attribute value may or may not depend on the active ingredient in the medicine.

An analyst with a device can examine the package and then said can log into a server and check that the compounds are correct for this package identifier. The server keeps track of correct and incorrect guesses. If there are attempts, e.g., more than 3, 4, 5, etc., with incorrect answers for the same package identifier, the server can either stop answering or report that the package is suspect the next person who asks about it. Incorrect guesses might result from a guessing compounds until he or she found the correct compounds. A counterfeiter motivated to do that might then create his or her own packaging and fake pills with proper compounds. Preferably, the identifier on each package will be not easy to guess so that a denial-of-service attacker cannot cause packages to appear invalid guessing the identifier and then deliberately giving incorrect compounds.

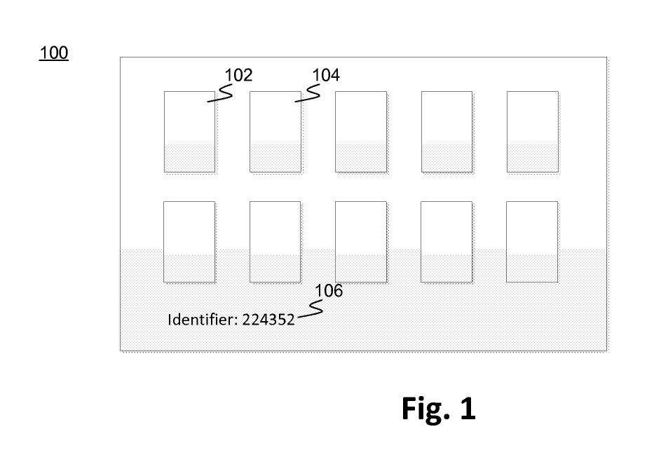

FIG. 1 illustrates a pill package 100 in accordance with an illustrative implementation. The pill package includes an identifier 106 and a number of pill compartments, e.g., 102 and 104. In other implementations, the identifier 106 can be located on the outer packaging of the pills in addition to or instead of the pill package 100. Each pill can be identified by an identifier printed near the pill compartments and/or by an identifier contained on the pill itself. Once the pill is consumed/analyzed, one or more previously hidden attributes, e.g., color, taste, smell, presence of a compound, can be detected. The attributes along with the identifier 106 and pill identifiers can be provided to a server, which can then verify if the provided attributes match one or more predetermined attributes associated with the identifier 106 and pill identifiers. For example, an identifier can be associated with two or more expected attributes. A match can be determined if the received one or more attributes match any of the two or more expected attributes. For example, the expected attributes can include that the color of the pill upon consumption can be blue or green. A received attribute of either blue or green will result in a match in this implementation. With regard to embodiments utilizing chemical analysis, the expected attributes can include that the compound of the pill upon analysis can be compound A or compound B. A received attribute of either compound A or compound B will result in a match in this implementation. In another implementation, the received attributes must match exactly the expected attributes.

Items such as pills may be identified individually by a global sequence two dimensional pattern of symbols or by the composition of a package number (constituting a group identifier) in which the pills are contained composed with an identifier (constituting a product identifier) 106 within the package. The goal is that each item or each small collection of items has a unique identifier, whether created through composition or not. The unique identifier is referred to as an item identifier. one embodiment, each small collection consists of a single pill, but the collection be made larger for cost reasons. As an example, the item identifier from FIG. 1 is composed of the identifier 106 and the pill identifier (not shown).

Each item identifier will be associated with one or more attribute values that are easily observable when the item is consumed/analyzed, but not otherwise. For example, an attribute value may be “has red dye,” “tastes like vanilla,” “has red dye and tastes like vanilla,” or “smells like garlic.” For example where the item is analyzed, an attribute value may be “has compound B.” Thus, an item identifier can be a single global string of symbols (e.g. letters, numbers, and other characters) or a combination of package identifier and an identifier within a package or any other mechanism that identifies either an individual item or a small collection of items. In one implementation, each item identifier identifies a single item, but it may identify a small collection. Further an item identifier can be associated with one or more attribute values and each item should have at least one of those attribute values.

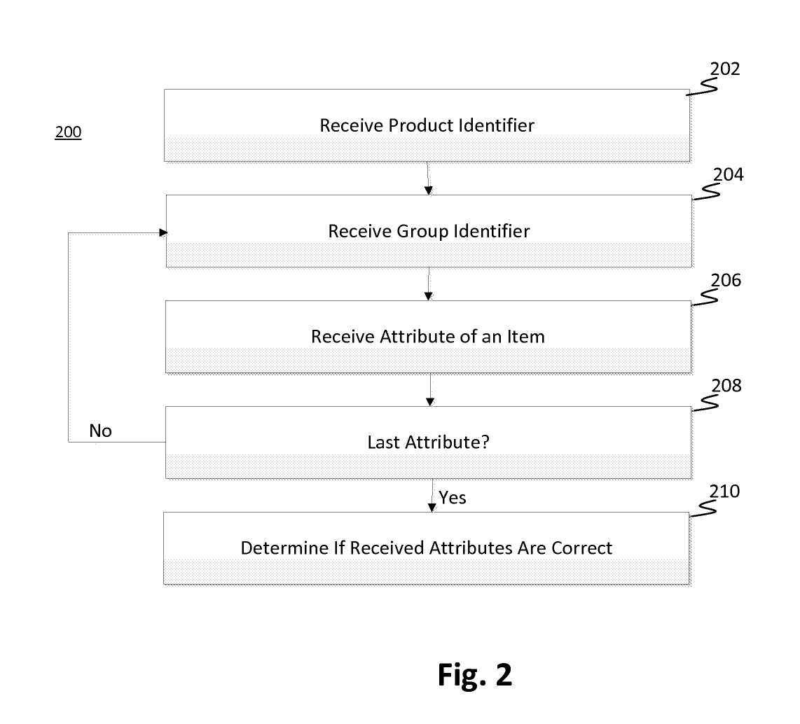

In one embodiment, while an item may have an item identifier an attribute, in order to facilitate anticounterfeiting, it is necessary to compare the determined attribute of an item to the expected attribute. FIG. 2 is a flow diagram determining if item attributes are correct in accordance with an illustrative implementation. A consumer can verify that an item is from a valid source by item identifiers and corresponding attributes. The attributes can be provided to the supplier of the items or to a remote server that has access to the expected attributes the items. In one implementation, the supplier and/or the remote server can be on the packaging of the item, e.g., a web address, a phone number, an email etc. In another implementation, the web address can be found on the website of the manufacturer. In an operation 202, a product identifier is received by the supplier a pharmaceutical manufacturer) or the remote server. For example, identifier 106 illustrated in FIG. 1. A group identifier can be received in an operation 204. The product identifier along with the group identifier can be combined to form the item identifier. The group identifier can be associated with a single item or with multiple items. The attribute that corresponds with the item identifier is received in an operation 206. Additional group identifiers of items and item attributes can be until all attributes that the end consumer wishes to send have been received (208). there are no further attributes, the received attributes can be used to determine if match the expected attributes in an operation 210. For example, the item identifier be used to look up the expected attribute in a data store. The expected attribute can then be matched against the received attribute. Thus, for example, a consumer or an analyst organization at the consumer's site can send information about a few sample packages to a manufacturer who can determine whether the attributes for the items the package are what they should be.

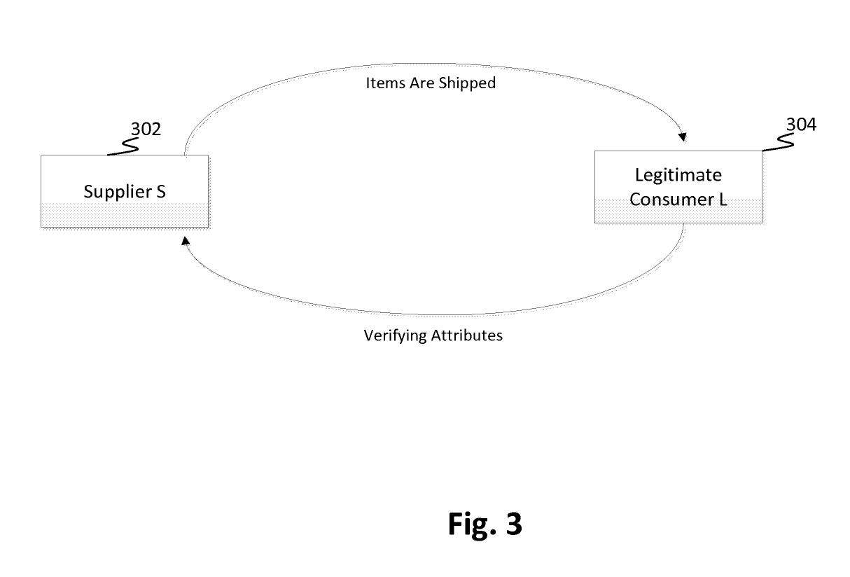

FIG. 3 is a diagram of an ideal communication between supplier and consumer in accordance with an illustrative implementation. A supplier 302 ships an item to a legitimate consumer 304. The shipping can be done through various shipping channels, e.g., wholesalers, retails, direct to consumer, etc. The legitimate consumer 304 analyzes the items and notes one or more attributes associated with each item. These attributes, along with item identifiers, can be sent to the supplier 302 or to a remote server (not shown) that verifies that the attributes are the correct attributes for the received item identifiers.

In one embodiment, the items may be consumables, such as drugs, in tablet, pill or capsule form. The attribute that is determined via analysis may be present on the surface of the item or embedded in the item. An attribute may also be present on the surface of or embedded within a package, envelope, or wrapping for the item. The attribute may be such that it is not visible by the human eye, for without analysis by a x-ray diffraction device. In one embodiment, the attribute is the presence of a compound, such as, but not limited to talc or metal oxides such as zinc oxide, magnesium oxide, and iron oxide. For embodiments where the package includes an attribute, the attribute may be the presence of a compound such as a metal or metal alloy.

For embodiments where the attribute is the presence of a compound, the analysis may be a qualitative and/or quantitative analysis. X-ray diffraction and X-ray microdiffraction, using compound verification and/or pattern recognition may be utilized.

### Intercept-and-Replace Attack

The invention as described so far defends against the counterfeiting of packaging, since the security resides at least partly in the attribute values of the pills. However, there remains a kind of man-in-the-middle style of attack.

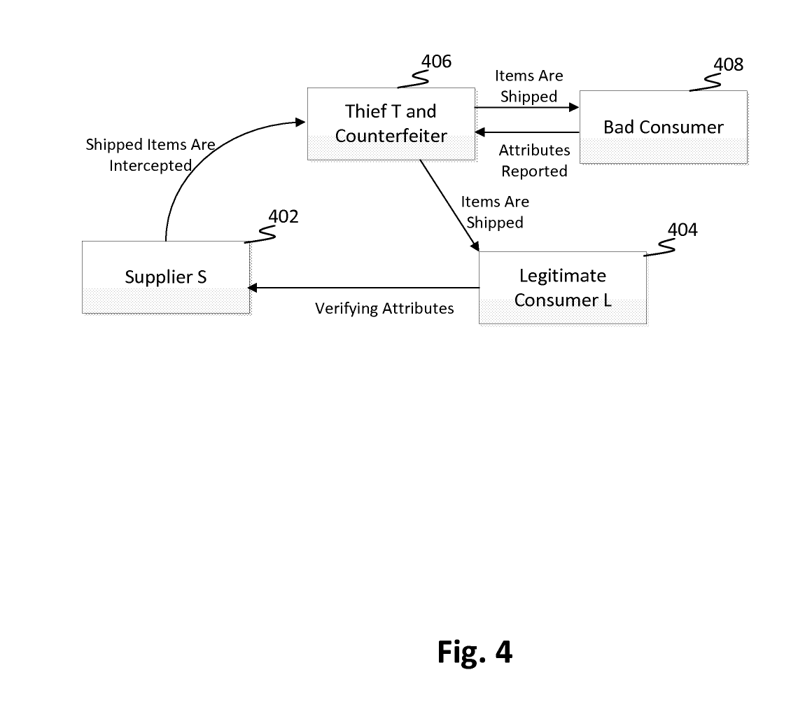

FIG. 4 is a diagram of an intercept-and-replace attack in accordance with an illustrative implementation. The intercept- and replace attack on the system works as follows, legitimate source/supplier S 402 ships to legitimate consumer L 404. The shipment is intercepted by a thief T 406 and sent to a complicit bad customer (for hidden attributes revealed by consumption) or an analyzer B (for chemical attributes) 408 who is willing to report to T 406 the attributes (such as color/compounds). The bad customer/analyzer B 408 may or may not pay T 406 for the real drug. T 406 gets the colors/compounds, produces fake pills with the correct attributes and ships them to L 404. L 404 reports the compounds back to S 402. Both L 404 and S 402 think that the pills are valid.

There are several defenses against this “Intercept-and-replace” attack. Because it takes some time for B 408 to redirect the pill for consumption or analyzing by a complicit party and for T 406 to match the packaging, L 404 will take longer than usual to get the pills. This extra time by itself might be observed in the verification protocol of FIG. 2. This delay can be used as an indication that the attribute data from the legitimate consumer L 404 is invalid. For example, L 404 or an ally of L (denoted A, where A may optionally be L or another party such as a trusted local pharmacy) is given a password that changes over time and is encouraged to report either individual pills, a package of pills, or perhaps an entire palette of pill packages (but not the contents yet) upon receipt. In that case, any delay would be detected.

Early detection of suspicious delays may be aided by a tracking manifest that notes when each leg of the shipment occurred. The legitimate receiver might transmit the contents of that manifest to the supplier S (to avoid forged manifests). Note that if the tracking manifest can ensure that the legitimate drugs make the first few legs of the journey, then any massive counterfeiting effort would require collusion among too many people to go undetected. Tracking could be done by automatic means (e.g. a global positioning system transmitter). An example Tracking Manifest is shown below in Table 1.

TABLE 1
Example Tracking Manifest
Tracking Manifest

Left Pharmaceutical Company on June 3, 2012 at 03:16
Arrived in town X on June 4, 2012 at 02:27
Arrived in town Y on June 4, 2012 at 05:07
Delivered to local pharmacy on June 4, 2012 at 06:21

The above defense as well as the defense below can depend upon the legitimate consumer L and/or the ally A being able to identify itself securely to the legitimate source S and vice versa. This is known as mutual authentication. This might involve the use of secure cellphones, a sequence of one-time passwords given on paper, a secure internet connection, or other mechanism. Such electronic security mechanisms are well-established technologies, increasingly so in the developing world. They can be compromised in individual cases and through dishonest employees, but in normal operation, they work well.

This same method would avoid another attack by which a counterfeiter might put a fake web address on the packaging, so that the legitimate consumer L the consumer ally A) effectively never communicate with S. The ensuing delay could then be detected by the server.

Another defense against the intercept-and-replace attack would be an attribute (consumable or compound) that changes over time or that can be changed based on a control signal from the source S. Thus, if the complicit bad consumer/analyzer B reports an attribute value at time t, but the attribute value is supposed to change by the time the legitimate consumer L consumes/analyzes the drug at time t′, the source S will know that there is a problem and can inform L.

One way to accomplish this is to make the attribute value have a certain lifespan. For example, for some pills, the consumable color will be red for only a week and then green. If L receives the pill after the week, the color-reported by B (red) will be put-in the counterfeit pill, but when L reports red, S will know there is a problem because L should have reported green.

In an alternative example, for some pills, the compound may react or decay over time to form a different compound with a different x-ray direction pattern. Thus, the pills may exhibit a first x-ray diffraction pattern for only a week and then exhibit a different x-ray diffraction pattern. If L receives the pill after the week, the first pattern reported by B (red) will be inserted in the counterfeit pill, but when L reports the first pattern, S will know there is a problem because L should have reported the second x-ray diffraction pattern based on the lapsed time.

An alternative to requiring that the attribute change on its own is to make it so that the attribute value changes based on electromagnetic or acoustical signals from a cell phone as provided by the source S when called by L. This could be a special sound signal that could alter some fluid in a pill or a light signal that has a certain orientation of a magnetic field. Still another alternative is for S to dictate some simple experiment to L before L consumes/analyzes it (e.g. put pills 6, 7, and 8 in the water and say which fizzes) but after L communicates with S.

Another defense against the intercept-and-replace attack is to use the inherent three dimensional structure of the pills to hide some physical property. This defense involves activity before the pill has been consumed in addition to (or conceivably instead of) the attribute value upon consumption. The idea is for the legitimate consumer L (or ally A) to take a very fine core sample of a specific pill in a specific way to find some “structural attribute value” like perhaps a certain sequence of colors or the presence of trace amounts of a fluorescent marker or -compound with a particular x-ray diffraction pattern. For example, a mutually authenticated communication, S may ask L to take pill 15, stick a very fine needle into that pill using a certain orientation and detect fluorescence. In another implementation, the pill can have a color or other attribute embedded in the pill, but not visible until the pill is broken. For example, the center of the pill can include a color that is visible once the pill is broken. The user can break the pill, for example, by using break lines that are common to pills, to reveal the inner color of the pill. In addition, the color can change over time, such that delays in the arrival of the pill can be deduced.

In another implementation, the pill can have a compound embedded in the pill, but not accessible for analysis until the pill is broken. An example of the use of a compound with a particular x-ray diffraction pattern may involve the center of the pill can including a compound that is visible once the pill is broken. The user can break the pill, for example, by using break lines that are common to pills, to reveal the inner compound of the pill. In addition, the compound can change over time, such that delays in the arrival of the pill can be deduced.

Using three dimensional structure in this way can also be used to it more difficult to counterfeit packaging. For example, the packaging could have the thickness of a centimeter and there could be papers of different colors at different locations of the packaging. A core sample at a particular location would yield a sequence of colors. Alternatively, the packaging could have the thickness of a centimeter and there could be papers of different colors at different locations of the packaging. A core sample at a particular location would yield a certain sequence of colors. Such locations could be identified by using measurements, e.g. go 4.7 centimeters from the left side and 3.4 centimeters from the top, stick in a needle and look at/analyze the colors/compounds. To duplicate the packaging would entail difficult chemical analysis.

A complementary idea to all the defenses above is to provide deliberate placebos in a pillbox, so that only when the authenticated legitimate consumer L communicates with the source S would S reveal which drugs were real and which were placebos. Such a strategy greatly reduces the value of the pills to a complicit B, because B would have to trust T to tell B which pills are placebos and which are not (and T is a thief so perhaps not so trustworthy).

As the supplier or remote server receives an indication that a user has taken a pill, this data can be collected and used in various ways. For example, by using the user's internet protocol address and/or domain, the location of the pills can be tracked. As another example, how consumers use the pills can also be deduced. This usage pattern can be compared with the ideal usage pattern and deviations can be noted. The supplier can then send the ideal usage pattern along with warnings regarding the consumer's actual usage of the pill to the consumer.

### Other Uses of Hidden Attributes

Hidden attributes can also be used in various other ways besides anti-counterfeiting measures. For example, candy can have hidden attributes. When the candy is eaten/analyzed, the one or more hidden attributes of the candy are revealed. These attributes can be sent to a remote server which can provide rewards and/or prizes for the correct entry of attributes. In addition, the number of correctly provided attributes can be logged and provided to the user, e.g., via a website. Points or credits can be awarded to the user for providing correct attributes. The points or credits can then be redeemed by the user for rewards and/or prizes, e.g., money, goods, services, etc.

In another implementation, the hidden attributes can be used as a means of winning rewards and/or prizes based upon a particular combination of hidden attributes. For example, a particular order of attributes can be deemed the winning combination. As a user eats/analyzes the candy and provides the attributes the candy, the attributes can be checked against the winning combination. If the provides the winning combination, rewards and/or prizes can be awarded to the user. In another implementation, there are multiple winning combinations for various rewards and/or prizes. For example, a consumer analyzing a candy to determine the same compound in three in a row and reporting those attributes can win additional candy. A consumer analyzing three candies that including a particular compound might win a reward and/or prize such as a bike or some other prize. In another nonlimiting example, a consumer eating three lemon tasting candies in a row and reporting those attributes can win additional candy. A consumer eating three cherry tasting candies that turn red in the consumer's mouth might win a reward and/or such as a bike or some other prize. As another example, a winning combination may be that the third, fifth, and seventh pieces of candy taste like cherry,

In addition, the consumer can register with a supplier or a remote server prior to providing the identifiers and revealed attributes. The consumer can provide demographic information, e.g., name, location, etc. Data from various consumers can then be analyzed for usage patterns. The analyzed data can be anonymous, in that consumer identifier information can be removed or replaced with non-identifying data. The usage data can be mined for market intelligence and/or targeted marketing. For example, data usage patterns can indicate how quickly or slowly a product is consumed, locations where a product is more or less popular, etc. Even if a consumer does not register, received data can still be useful for marketing. As an example, usage patterns can still be recorded and analyzed from users that provide identifiers and revealed attributes but are not registered.

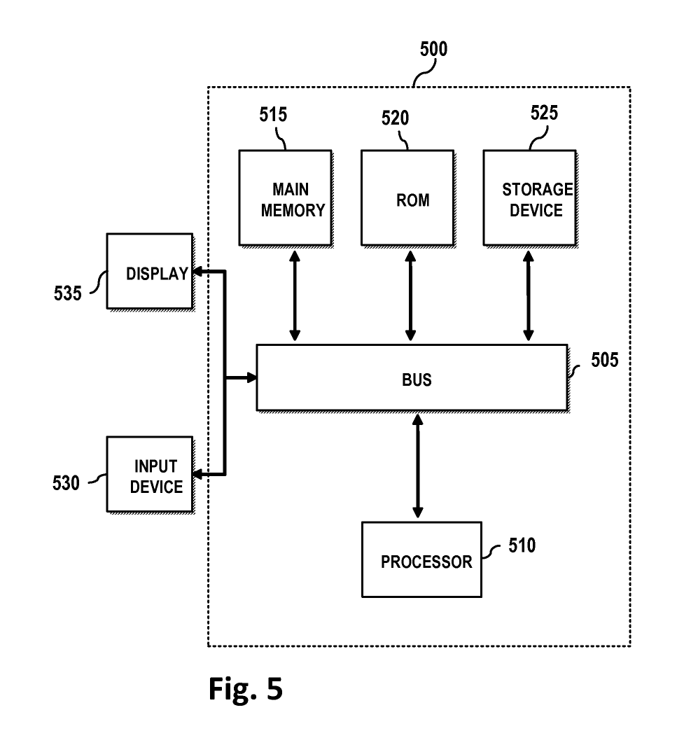

In one embodiment, a computer system is utilized with the system and methods for anti-counterfeiting. For example, computerized methods may utilize a computer to process received information regarding product attributes, item product identifiers, and/or group identifiers. FIG. 5 is a block diagram of a computer system in accordance with an illustrative implementation. The computing system includes a bus 505 or other communication component for communicating and a processor 510 or processing circuit coupled to the bus 505 for processing information. The computing system 500 can also include one or more processors or processing circuits coupled to the bus for processing information. The computing system 500 also includes main memory 515, such as a random access memory or other dynamic storage device, coupled to the bus 505 for storing information, and instructions to be executed by the processor 510. Main memory 515 can also be for storing position information, temporary variables, or other intermediate during execution of instructions by the processor 510. The computing system 500 further include a read only memory (ROM) 510 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of contained in main memory 515 causes the computing system 500 to perform the illustrative processes described herein. One or more processors in a multi-arrangement may also be employed to execute the instructions contained in main memory 515. A computer storage medium can be, or be included in, a computer-computer-readable storage device, a computer-readable storage substrate, a or serial access memory array or device, or a combination of one or more of them. Moreover, while a computer storage medium is not a propagated signal, a computer storage medium can be a source or destination of computer program instructions encoded in an artificially-generated propagated signal. The computer storage can also be, or be included in, one or more separate components or media (e.g., multiple CDs, disks, or other storage devices). Accordingly, the computer storage medium is both tangible and non-transitory.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While this specification contains many specific implementation details, these should not be construed as limitations on the scope of any inventions or of may be claimed, but rather as descriptions of features specific to particular implementations of particular inventions. Certain features described in this specification in the context of separate implementations can also be implemented in combination in a single implementation. Conversely, various features described in context of a single implementation can also be implemented in multiple implementations separately or in any suitable subcombination. Moreover, although features may be described above as acting in certain combinations and even initially claimed as such, one or more features from a claimed combination can in some be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A product comprising:
a plurality of items each having an item identifier and a hidden attribute, wherein each of the plurality of items is configured to reveal the hidden attribute and the item identifier and hidden attribute are associated for each of the plurality of items whereby a predetermined association with the item identifier and hidden attribute for an item is tested.

2. The product of claim 1, wherein the item identifier includes one or more product identifier, group identifier and identifier within a group.

3. The product of claim 1, wherein the item identifier comprises a product packaging comprising the product identifier and an identifier within the package.

4. The product of claim 1, wherein each item is configured to reveal the hidden attribute upon analysis

5. The product of claim 4, wherein the hidden attribute is the presence of a compound.

6. The product of claim 5, wherein the compound is a metal or metal oxide.

7. The product of claim 4, wherein the hidden attribute is a compound.

8. The product of claim 7, wherein the compound is biocompatible.

9. The product of claim 1, wherein the item identifier is shared by a subset of the plurality of items.

10. The product of claim 1, wherein the item identifier is different for each of the plurality of items.

11. The product of claim 1, wherein the item identifier is attached to the item.

12. The product of claim 1, wherein the plurality of items are selected from the group consisting of pills, candy, food and items of a perishable nature.

13. A method comprising,
receiving an item identifier that identifies an item;
receiving an attribute associated with the item, wherein the attribute is based upon a hidden attribute and wherein the item is associated with the item identifier; and
determining, using a processor, if the received attribute matches an expected attribute, wherein the expected attribute is associated with the item identifier.

14. The method of claim 13, wherein the hidden attribute is revealed upon analysis of the item.

15. The method of claim 14, wherein the analysis comprises x-ray diffraction.

16. The method of claim 13 wherein the hidden attribute is revealed upon consumption of the item.

17. The method of claim 16, wherein the attribute is selected from the group comprising taste, color, and smell.

18. The method of claim 13, wherein the item identifier comprises a product identifier and a group identifier, wherein each item of a plurality of items has a group identifier, and wherein the item identifier identifies one or more items and comprises the product identifier and the group identifier;

19. The method of claim 13, further comprising providing an indication based upon determining if the received attribute matches an expected attribute.

20. The method of claim 13, further comprising:
updating an error count associated with the product identifier if the received attribute does not match the expected attribute; and
determining whether the received attribute matches an expected attribute based upon the error count being above a predetermined threshold.

21. The method of claim 13, further comprising receiving an analysis identifier, a time and an indication that a package containing the product identifier has arrived at a location.

22. The method of claim 21, further comprising:
determining a total shipping time based upon the received time; and
taking an action based upon the total shipping time exceeding a predetermined time.

23. The method of claim 13, further comprising determining a location of a consumer based upon the product identifier.

24. The method of claim 13, wherein the hidden attribute changes over time.

25. The method of claim 13, further comprising providing a signal to at least one item, wherein the signal changes the hidden attribute of the at least one item.

26. The method of claim 13, further comprising:
providing an instruction to perform a test on at least one item without consuming the item; and
receiving a result associated with performance of the provided instruction.

27. The method of claim 13, further comprising receiving results of a test of some property of a three dimensional structure of at least one item.

28. The method of claim 18, further comprising providing an indication as to which of the plurality of items are placebos.

29. The method of claim 18, further comprising:
receiving a plurality of attributes associated with the plurality of items, wherein the plurality of attributes includes the received attribute;
determining a reward based upon matching the received plurality of attributes with an expected plurality of attributes, wherein the expected plurality of attributes are associated with at least the product identifier.

30. A product comprising:
a plurality of items, wherein each item has an item identifier and a hidden attribute, wherein each item is configured to reveal the hidden attribute upon consumption;
a product identifier, wherein each item has a group identifier, and wherein the item identifier comprises the product identifier and the group identifier.

31. The product of claim 30, wherein the hidden attribute is a color.

32. The product of claim 30 wherein the hidden attribute is taste.

33. The product of claim 30, wherein the hidden attribute is a smell.
